(19) United States
(12) Patent Application Publication
(10) Pub. No.: US 2025/0291615 A1
(43) Pub. Date: Sep. 18, 2025

(54) LANGUAGE MODEL-BASED VIRTUAL ASSISTANTS FOR CONTENT STREAMING SYSTEMS AND APPLICATIONS

(71) Applicant: NVIDIA Corporation, Santa Clara, CA (US)

(72) Inventors: Jason Paul, Los Gatos, CA (US); Guillermo Siman, Mountain View, CA (US); Jason Mawdsley, San Jose, CA (US); Nikhil Prasad, Bangalore (IN); Deep Shekhar, Bangalore (IN); Henry Cheng-Han Lin, Belmont, CA (US); Ram Rangan, Chennai (IN); Anjul Patney, Kirkland, WA (US); Ritesh Kumar, Bangalore (IN); Seth Schneider, San Jose, CA (US)

(21) Appl. No.: 18/606,278

(22) Filed: Mar. 15, 2024

(51) Int. Cl. G06F 9/451; G06F 16/432

(52) U.S. Cl. CPC G06F 9/453; G06F 16/434

(57) ABSTRACT

In various examples, providing virtual assistants for content streaming systems and applications is described herein. For instance, systems and methods are disclosed that use a virtual assistant associated with an application, such as a gaming application, to at least process queries received from a user in order to provide the user with information on how to perform various tasks associated with the application. In some examples, to determine the output information, data associated with the application is processed in order to determine state information describing a current state of the application. Additionally, the query, the state information, and/or additional information may be used to determine contextual information related to the query. One or more language models may then process the query and/or the information to determine the output information associated with the query. The output information may then be provided using various techniques, such as text, graphics, and/or audio.

### BACKGROUND

Gaming applications have become more complex in order to add richness, excitement, and challenges for players. For example, gaming applications have increased at least the number and/or difficulty of objectives and achievements (e.g., quests, paths, and/or levels, etc.) to complete, the number and/or types of items and/or attributes that are available to obtain, and/or the number and/or types of characters that are available for interaction. As such, for many players, such as players with no or little experience with the gaming applications, there may be a steep learning curve that causes the players to either lose interest in playing the gaming applications, or motivate the players to seek, search, and identify external help for proceeding through the gaming applications. For instance, players may use resources that are external to the sessions of the applications, such as manuals, documents, and/or videos that help walk the players through the gaming applications, such as to complete tasks that may be difficult for the players. However, for many players, it may still be difficult to identify external resources that are relevant to the gaming applications and/or the tasks of the gaming applications for which the players need help. Furthermore, searching for and reviewing relevant resources take time away from gameplay, which can impact the player experience negatively.

### SUMMARY

Embodiments of the present disclosure relate to providing virtual assistants for content streaming systems and applications. Systems and methods are disclosed that use a virtual assistant associated with an application, such as a gaming application, to at least process queries received from a user in order to provide the user with information on how to perform various tasks associated with the application. For instance, data associated with the application, such as image data, audio data, input data, user data, and/or any other type of data, may be used to determine state information describing a current state of the application. When receiving a query from a user, this state information and/or the query may then be used to retrieve contextual information that is relevant to the application, the state, and/or the query. One or more language models (e.g., one or more large language models, etc.) may then process input data (e.g., a prompt) representative of at least the state information, the contextual information, and the query. Additionally, based at least on the processing, the language model(s) may generate or otherwise output data representing information associated with the query, such as a response, that is then provided back to the user.

In contrast to conventional systems, such as those described above, the systems of the present disclosure use the virtual assistant that is able to provide information to users, such as responses to queries, within a session of an application. This way, the users do not have to perform searches using resources that are external to the session and/or use external devices when searching for how to perform various tasks associated with the application. Additionally, and as described in more detail herein, by using the language model(s) that processes the state information, the contextual information, and/or additional information (e.g., past queries and/or retrieved information) to determine the information associated with the query, the systems of the present disclosure may provide information that is more specific to the tasks being queried by the users. In some circumstances, providing such information during the session may help keep the users engaged with the application.

### BRIEF DESCRIPTION OF THE DRAWINGS

The present systems and methods for providing virtual assistants for content streaming systems and applications are described in detail below with reference to the attached drawing figures, wherein:

FIG. 1 illustrates an example data flow diagram for a process of using a virtual assistant to provide information associated with an application, in accordance with some embodiments of the present disclosure;

FIGS. 2A-2B illustrate examples of using application data to determine a current state associated with an application, in accordance with some embodiments of the present disclosure;

FIG. 3 illustrates an example of using inputs to generate a query associated with an application, in accordance with one or more examples of the present disclosure;

FIG. 4 illustrates an example of generating or updating one or more databases that store contextual information associated with an application, in accordance with some embodiments of the present disclosure;

FIG. 5 illustrates an example of generating input data for one or more language models, in accordance with some embodiments of the present disclosure;

FIGS. 6A-6B illustrate examples of providing information associated with a query within a session associated with an application, in accordance with some embodiments of the present disclosure;

FIG. 7 illustrates an example of one or more language models determining information associated with a query, in accordance with some embodiments of the present disclosure;

FIG. 8 illustrates an example of an architecture for providing an AI assistant associated with an application, in accordance with some embodiments of the present disclosure;

FIG. 9 illustrates a flow diagram showing a method for using one or more language models to provide information related to queries associated with an application, in accordance with some embodiments of the present disclosure;

FIG. 10 illustrates a flow diagram showing a method for maintaining a state associated with an application, in accordance with some embodiments of the present disclosure;

FIG. 11 is a block diagram of an example content streaming system suitable for use in implementing some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Systems and methods are disclosed related to providing virtual assistants for content streaming systems and applications. For instance, a system(s) may receive data (referred to, in some examples, as “application data”) associated with an application that is being streamed between one or more application servers and one or more client devices. As described herein, the application data may include, but is not limited to, image data representing one or more frames being presented using the client device(s) (e.g., from a field-of-view (FOV) of the user(s)), image data representing one or more frames associated with different perspectives of the gaming environment (e.g., from one or more other FOVs), audio data representing one or more sounds being output using the client device(s), audio data representing one or more sounds being captured using the client device(s), input data representing one or more inputs received using the client device(s), user data representing information associated with the user(s) (e.g., one or more skill level(s) and/or playstyles of the user(s)) and/or any other type of data associated with the application. In some examples, the system(s) may include and/or be part of the application server(s) that is streaming content data (e.g., the image data, the output audio data, etc.) to the client device(s). In some examples, the system(s) may include and/or be part of the client device(s) that is providing the content data. Still, in some examples, the system(s) may be remote from, and communicate with, the application server(s) and/or the client device(s).

The system(s) may then use at least a portion of the application data to determine a current state of the application. As described herein, in some examples, the current state may be represented using information (referred to, in some examples, as “state information”) associated with the application, such as information describing one or more characteristics of the application. For example, the state information may describe graphics represented by the application data, such one or more locations, one or more items, one or more attributes, one or more characters, one or more tasks, one or more actions, and/or the like depicted by the frame(s), text represented by the application data, such as text depicted by the frame(s), information associated with the user(s), such as the playstyle(s) of the user(s), and/or any other characteristic associated with the application. Additionally, the state information may be described using text, such as text that includes letters, numbers, characters, symbols, words, sentences, and/or the like. In some examples, the system(s) may use various techniques to determine the state information based at least on processing the application data.

For a first example, if the application data includes image data, the system(s) may use one or more machine learning models (e.g., one or more computer-vision models) to process the image data and generate text describing graphics associated with the frame(s) of the image data. For instance, the text may describe a location, a character, an item, and/or the like depicted by the frame(s). For a second example, and again if the application data includes image data, the system(s) may process the image data to perform optical character recognition (OCR) in order to identify text corresponding by the frame(s). For instance, the text may include words, numbers, symbols, and/or the like depicted by the frame(s). While these are just a few example techniques of how the system(s) may process the application data in order to generate the state information, in other examples, the system(s) may use additional and/or alternative techniques.

In some examples, the system(s) may then store data representing the state information. Additionally, in some examples, such as when the system(s) continues to receive additional application data, such as additional image data representing additional frames associated with the application, the system(s) may continue to perform these processes in order to update the state information associated with the application. Furthermore, in some examples, and as described more herein, the system(s) may use other types of data to determine and/or update the state information, such as data generated by the application that specifies the state of the application, data associated with previous sessions of the application that indicate the states at those previous sessions, data (referred to, in some examples, as “history data”) representing one or more previous queries and/or information determined for the one or more previous queries, and/or any other data.

The system(s) may also receive data (referred to, in some examples, as “query data”) representing a query associated with the application. As described herein, the query may include a request for information associated with the application, a question on how to perform a task (e.g., find an item, beat a character, accomplish a mission, etc.) associated with the application, an inquiry associated with the application, and/or any other type of query. Additionally, the query data may include, but is not limited to, text data representing text corresponding to the query, audio data representing user speech corresponding to the query, input data representing a portion of displayed content that corresponds to the query, and/or any other type of data. In some examples, based at least on receiving the query, the system(s) may use the query, the state information, and/or additional information (e.g., previous queries and/or information represented by the history data) to retrieve information (referred to, in some examples, as “contextual information”) associated with the query, the state, and/or the application.

For instance, the system(s) may store and/or have access to one or more databases that are associated with contextual information for the application. In some examples, the database(s) may be associated with a retrieval augmented generation (RAG) system. For example, the system(s) (e.g., the RAG system) may identify, such as by using one or more external resources, data associated with the application. As described herein, the data may represent documents, comments, discussion boards, websites, manuals, graphics, videos, audio, and/or any other type of content that may include information associated with the application. For a first example, such if the application includes a gaming application, the data may represent one or more documents corresponding to a walkthrough of how to proceed through the game. For a second example, such as if the application again includes a gaming application, the data may represent a video of a person describing and/or displaying how to proceed through at least a portion (e.g., a task) of the game. Still, for a third example, such as if the application includes an application for inputting information (e.g., text information, financial information, company information, etc.), such as in a spreadsheet, the data may represent a user manual associated with the application.

The system(s) may then generate text associated with the content. For a first example, if the content includes one or more documents, then the system(s) generate the text as including the text from the document(s). For a second example, if the content includes a video, then the system(s) may generate text to represent speech from the video and/or generate text describing graphics displayed within the video. In some examples, the system(s) may then segment the text into chunks, where a chunk may represent a character, a word, a sentence, a paragraph, and/or any other portion of text. The system(s) may then convert the chunks of text into vectors that the system(s) then stores in the database(s). Additionally, in some examples, the system(s) stores, in the database(s), links that include pointers back to the original content and/or the text that was used to generate the vectors. This way, and as described in more detail herein, the system(s) is able to use the query, the state information, and/or the additional information to retrieve the necessary text and/or content (e.g., document(s), etc.) associated with the contextual information for the query.

The system(s) may then generate input data corresponding to a prompt that is associated with the query. As described herein, the input data may represent at least the state information, the contextual information, and the query. Additionally, in some examples, the input data may represent additional information, such as one or more past queries associated with the application, information determined for the one or more past queries, the playstyle(s) of the user(s), and/or any other information. In some examples, the input data may represent tokens corresponding to the state information, the contextual information, the query, and/or the additional information. In some examples, the input data may represent vectors and/or embeddings corresponding to the tokens. In either example, the system(s) may then apply the input data to one or more language models, such as one or more large language models, that are configured to process at least a portion of the input data. Additionally, based at least on the processing, the language model(s) may output data representative of information (referred to, in some examples, as output information) associated with the query, such as a response to the query.

For example, the output data may represent vectors and/or embeddings corresponding to the output information. As such, the system(s) may process the vectors and/or embeddings and, based at least on the processing, generate tokens corresponding to the output information. After generating the tokens, the system(s) may use the tokens to generate text representing the output information. For example, if the query is a question asking, “Which direction should I go to find the next boss,” then the output information may include a response such as, “You should advance in your current direction and towards the castle, where the boss is located within a room on the second floor.” After generating the output information, the system(s) may then cause the client device(s) to provide the output information to the user(s) using one or more techniques.

For a first example, the system(s) may generate audio data representing speech corresponding to the output information and then send the audio data to the client device(s). Based at least on receiving the audio data, the client device(s) may output the speech using one or more speakers. For a second example, the system(s) may generate text data representing one or more words corresponding to the output information and send the text data to the client device(s). Based at least on receiving the text data, the client device(s) may present the text using a display (e.g., as an overlay to the frame(s) of the application). Still, for a third example, the system(s) may generate content data representing one or more graphics associated with the output information, such as one or more arrows indicating a direction for which to proceed, and send the content data to the client device(s). Based at least on receiving the content data, the client device(s) may present the graphic(s) using a display (e.g., as an overlay to the frame(s) of the application). While these are just a few example techniques of how the system(s) may cause the client device(s) to provide the output information, in other examples, the system(s) may use additional and/or alternative techniques.

In some examples, the system(s) may then perform one or more additional processes using the query and/or the output information. For instance, the system(s) may generate and/or update history data to represent the query and/or the output information, update the state information based at least on the query and/or the output information, and/or perform any other process. This way, the next time that the system(s) receives a new query from the user(s), the system(s) is able to use the history and/or the updated state information when determining how to respond to the new query. In some embodiments, the system(s) is able to weave output information as a continuation of a conversation, based on context from previous player interactions (e.g., conversation history, etc.), rather than a piece of standalone information.

While the examples herein describe the language model(s) as being separate from the processes that determine the state information and/or the contextual information, in some examples, the language model(s) may determine and/or maintain the state information associated with the application, determine the contextual information associated with the query, and/or determine the output information associated with the query. Additionally, while the examples herein describe the language model(s) processing the contextual information in order to determine the output information, in other examples, the language model(s) may not process the contextual information. For instance, in such examples, the language model(s) may be able to determine the output information directly from state information and queries.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

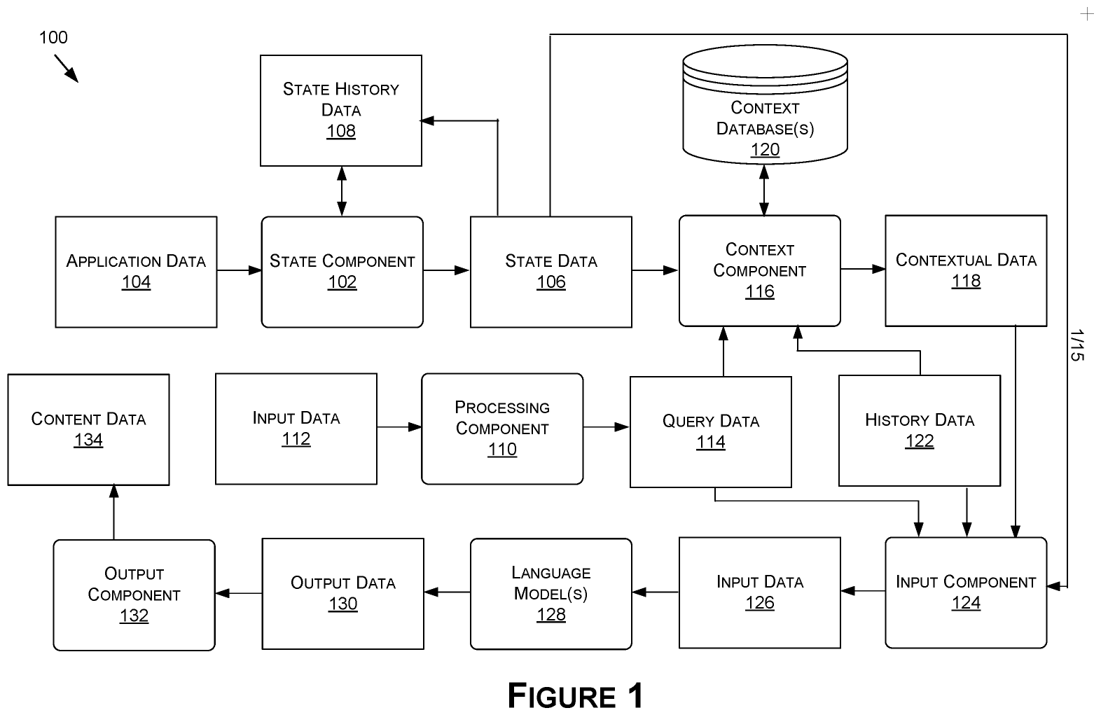

With reference to FIG. 1, FIG. 1 illustrates an example data flow diagram for a process 100 of using a virtual assistant to provide information associated with an application, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include a state component 102 using application data 104 (also referred to, in some examples, as “content data 104”) associated with an application to determine a current state of the application, where the current state is represented by state data 106. As described herein, the application may be, include, or be included as a feature of, without limitation, a gaming application, an interactive application, a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, or any other type of application. Additionally, application data 104 may include, but is not limited to, image data representing one or more frames being presented using the client device(s) (e.g., from a FOV of the user(s)), image data representing one or more frames associated with different perspectives of the gaming environment (e.g., from one or more other FOVs) that may be presented using the client device(s), audio data representing one or more sounds being output using the client device(s), audio data representing one or more sounds captured using the client device(s), input data representing one or more inputs received using the client device(s), user data representing information associated with the user(s) (e.g., one or more skill levels of the user(s), one or more amounts of time that the user(s) has used the application, one or more playstyles associated with the user(s), etc.) and/or any other type of data associated with the application.

In some examples, to determine the current state of the application, the state component 102 may determine state information that describes the current state, such as information describing one or more characteristics associated with the application. For instance, the state information may describe graphics represented by the application data, such one or more locations, one or more items, one or more attributes, one or more characters, one or more tasks, one or more actions, and/or the like depicted by the frame(s), text represented by the application data, such as text depicted by the frame(s), information associated with the user(s), such as the playstyle(s) of the user(s), and/or any other characteristic associated with the application. Additionally, in some examples, the state information may be represented using text. For example, the state information may include, “The location is in the west mountains, there are two friendly characters nearby, the main character is holding a sword and a magic portion, and the main character is moving in a direction that is 345 degrees,” although this is just one example of state information. In some examples, the state component 102 may use various techniques to determine the state information based at least on processing the application data 104.

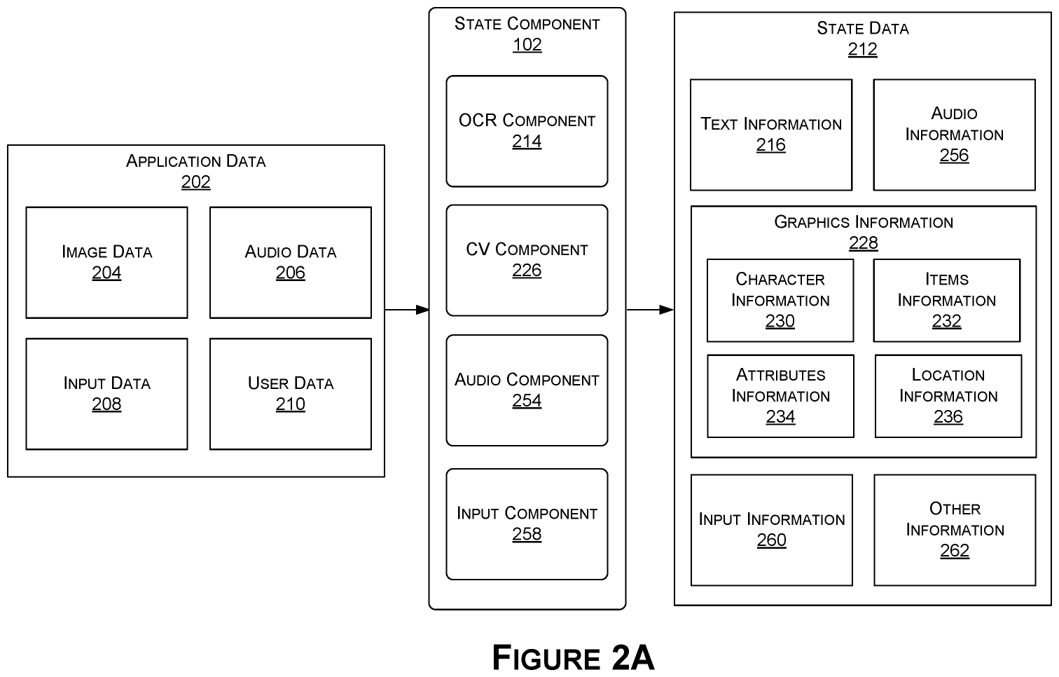

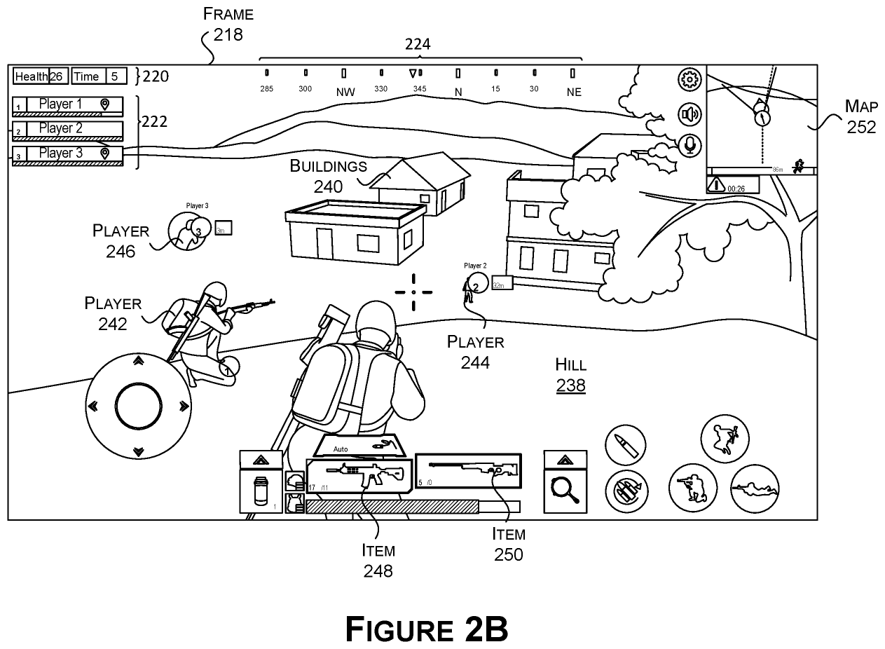

For instance, FIGS. 2A-2B illustrate examples of using application data 202 (which may represent, and/or include, the application data 104) to determine a current state associated with an application, in accordance with some embodiments of the present disclosure. As shown by the example of FIG. 2A, the state component 102 may receive the application data 202 associated with the application. In the example of FIG. 2A, the application data 202 may include at least image data 204, audio data 206, input data 208, and user data 210. Additionally, the state component 102 may use various processing components to process the application data 202 in order to determine the current state of the application, where the current state is represented by state data 212 (which may represent, and/or include, the state data 106).

For instance, the state component 102 may process the image data 204 using an optical character recognition (OCR) component 214 that is configured to identity text represented by the frame(s). Based at least on identifying the text, the OCR component 214 may generate text information 216 describing the text, such as in the form of machine-encoded text. For example, and referring to the example of FIG. 2B, based at least on processing a frame 218, the OCR component 214 may generate information describing text 220 that is associated with a health of the player and a remaining time, such as “Health 26” and “Time 5”, text 222 that is associated with a number of remaining teammates, such as “Player 1”, “Player 2”, and Player 3″, and text 224 that is associated with a direction the players is moving, such as “345”. While these are just a few examples of text that may be identified by the OCR component 214 processing the frame 218, in other examples, the OCR component 214 may identify additional and/or alternative text associated with the frame 218.

Referring back to the example of FIG. 2A, in some examples, the state component 102 may use a computer-vision (CV) component 226 that is configured to determine graphics information 228 associated with the frame(s). As described herein, the CV component 226 may use one or more machine learning models, one or more neural networks, one or more modules, one or more algorithms, and/or any other component to determine the graphics information 228. Additionally, the CV component 226 may perform one or more techniques to generate the graphics information 228, such as, but not limited to, object detection, template matching, image captioning, video captioning, and/or any other CV technique. Furthermore, the graphics information 228 may describe various characteristics associated with the application, such as character information 230, items information 232, attributes information 234, location information 236, and/or any other type of information.

For example, and referring back to the example of FIG. 2B, based at least on processing the frame 218, the CV component 226 may generate text 238 describing that the “player is located on a hill”, text 240 describing that the “player is oriented towards buildings”, text 242 describing that “player 1 is also located on the hill”, text 244 describing that “player 2 is located below the hill and next to the buildings”, text 246 describing that “player 3 is located below the hill”, text 248 describing that “player is holding a first item that includes a first weapon”, text 250 describing that “player has a second item that includes a second weapon in inventory”, text 252 that describe the map, and/or text describing any other graphic of the frame 218. The reference characters 238-252 illustrated in the example of FIG. 2B illustrate the graphics that are being described with respect to the state information.

Referring back to the example of FIG. 2A, in some examples, the state component 102 may use an audio component 254 that is configured to determine audio information 256 associated with sound represented by the audio data 206. For instance, the audio component 254 may process the audio data to perform one or more audio processing techniques, such as natural language understanding (NLU), automatic speech recognition (ASR), sound recognition, voice recognition, and/or any other type of audio processing. In some examples, the audio information 256 may include text describing the sounds recognized by the audio component 254, such as text representing speech. For example, the audio information 256 may include text that describes user speech such as, “We need to move down the hill and towards the buildings.”

In some examples, the state component 102 may use an input component 258 that is configured to determine input information 260 associated with the input(s) as represented by the input data 208. For instance, the input information 260 may represent the input(s) being received by the client device(s) that is presenting the application. For a first example, if the user moves a joystick in a specific direction, then the input information 260 may include text that describes “the joystick moved forward.” For a second example, if the use presses a specific button, such as the “X” button, then the input information 260 may include text describing “input to X.”

In some examples, the state component 102 may determine additional information 262 that may be important to the current state of the application. For example, the other information 262 may include a skill level(s) and/or playstyle(s) associated with the user(s), as represented by the user data 210, and/or previous state information associated with previous states of the application. In some examples, the state component 102 may determine the previous states using one or more techniques. For a first example, the state component 102 may determine one or more of the previous states using one or more of the processing techniques described herein. For a second example, the state component 102 may determine one or more of the previous states based at least on data associated with one or more saving states associated with one or more previous sessions of the application. For a third example, the state component 102 may determine one or more of the previous states based at least on the application data 202 specifying the previous state(s) (e.g., the application may be associated with tags indicating various states throughout the application). While these are just a few example techniques of how the state component 102 may determine the previous state(s), in other examples, the state component 102 may use additional and/or alternative techniques.

While the example of FIGS. 2A-2B describes determining the state using the frame 218 that is being presented using the client device(s), in some examples, the state component 102 may determine the state using one or more other, virtually generated frames. For example, the image data 204 may represent the other frame(s) depicting one or more other FOVs of the application environment, such as a FOV from another player, a FOV from a different angle that also depicts the main character, and/or any other FOV associated with the application environment. In some embodiments, one or more of the other frame(s) may not be presented using the client device(s). The state component 102 may then perform similar processes, as those described herein with respect to the frame 218, to generate state information associated with the other frame(s). In some examples, by performing such processes, the state information may better represent the state of the application, such as by including additional information associated with the state that is not depicted in the frame 218.

Referring back to the example of FIG. 1, the process 100 may include the state component 102 generating and/or outputting the state data 106 representing the current state of the application. For instance, the state data 106 may represent state information associated with the current state, such as in the form of text. Additionally, in some examples, the state component 102 may store the state data 106 as part of state history data 108, where the state history data 108 represents one or more previous states associated with the application. As described herein, the state component 102, and/or one or more other components, may use the state data 106 and/or the state history data 108 to perform one or more operations.

As further illustrated by the example of FIG. 1, the process 100 may include a processing component 110 processing input data 112 and, based at least on the processing, generating query data 114 representing a query. As described herein, the processing component 110 may use different techniques to generate the query data 114. For a first example, such as if the input data 112 represents text that is input by a user, such as into the client device(s), then the processing component 110 may generate the query data 114 to represent at least a portion of the text. For a second example, such as if the input data 112 includes audio data representing user speech, then the processing component 110 may process the audio data to perform one or more audio processing techniques. For example, the processing component 110 may perform ASR on the audio data in order to generate text (e.g., a transcript) representing at least a portion of the speech, where the text is again represented by the query data 114. While these are just a few examples of how the processing component 110 may generate the query data 114 using different types of input data 112, in other examples, the processing component 110 may use any other type of processing to generate the query data 114 using any other type of input data.

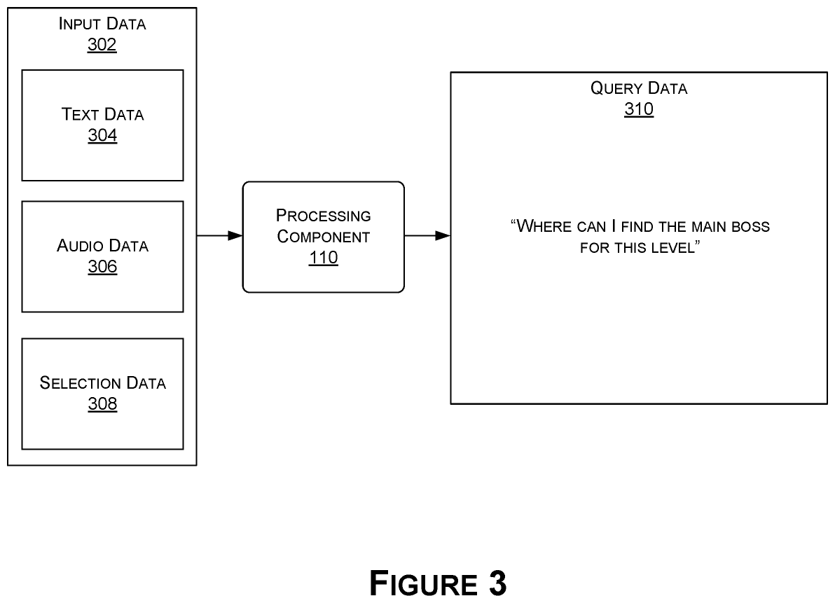

For instance, FIG. 3 illustrates an example of using input data 302 (which may represent, and/or include, the input data 112) to generate a query associated with an application, in accordance with one or more examples of the present disclosure. As shown, the input data 302 may include, but is not limited to, text data 304 representing text, audio data 306 representing speech, and/or selection data 308 representing a selection of at least a portion of content associated with the application. As such, the processing component 110 may process the input data 302 and, based at least on the processing, generate query data 310 (which may represent, and/or include, the query data 114) representing the query corresponding to the input data 302. For instance, and in the example of FIG. 3, the query may include, “Where can I find the main boss for this level.”

For a first example, if the input data 302 includes the text data 304 representing the text, “Where can I find the main boss for this level,” then the processing component 110 may generate the query data 310 using the text from the text data 304. For a second example, if the input data 302 includes the audio data 306 representing the speech, where the speech includes at least, “Where can I find the main boss for this level,” then the processing component 110 may process the audio data 306 to perform ASR (and/or any other speech processing technique) to generate an output (e.g., text, an encoding or embedding, etc.) representing the speech. Still, for a third example, if the input data 302 includes the selection data 308, such as the user(s) selecting an icon associated with the main boss and/or the level to indicate that the user(s) is searching for the main boss, then the processing component 110 may use the selection to automatically generate the query data 310.

Referring back to the example of FIG. 1, the process 100 may include a context component 116 using at least the state data 106 representing the current state and the query data 114 representing the query to retrieve contextual information associated with the application, the current state, and/or the query, where the contextual information is represented by contextual data 118. For instance, the context component 116 may store and/or have access to one or more databases 120 that are associated with contextual information for the application. In some examples, the context component 116 may include a RAG system and the database(s) 120 may include one or more RAG databases.

For example, the context component 116 may identify, such as by using one or more external resources, data associated with the application. As described herein, the data may represent documents, comments, discussion boards, websites, manuals, graphics, videos, audio, and/or any other type of content that may include information associated with the application. For a first example, such if the application includes a gaming application, the data may represent one or more documents corresponding to a walkthrough of how to proceed through the game. For a second example, such as if the application again includes a gaming application, the data may represent a video of a person describing and/or displaying how to proceed through at least a portion (e.g., a task) of the game. Still, for a third example, such as if the application includes an application for inputting information (e.g., text information, financial information, company information, etc.), such as in a spreadsheet, the data may represent a user manual associated with the application.

The context component 116 may then generate text associated with the content. For a first example, if the content includes one or more documents, then the system(s) generate the text as including the text from the document(s). For a second example, if the content includes a video, then the system(s) may generate text (e.g., a transcript) to represent speech from the video and/or generate text describing graphics displayed within the video, using one or more of the processes described herein. In some examples, the context component 116 may then segment the text into chunks, where a chunk may represent a character, a word, a sentence, a paragraph, and/or any other portion of text. The context component 116 may then convert the chunks of text into vectors that the context component 116 then stores in the database(s) 120. Additionally, in some examples, the context component 116 stores, in the database(s) 120, links that include pointers back to the original content and/or the text that was used to generate the vectors.

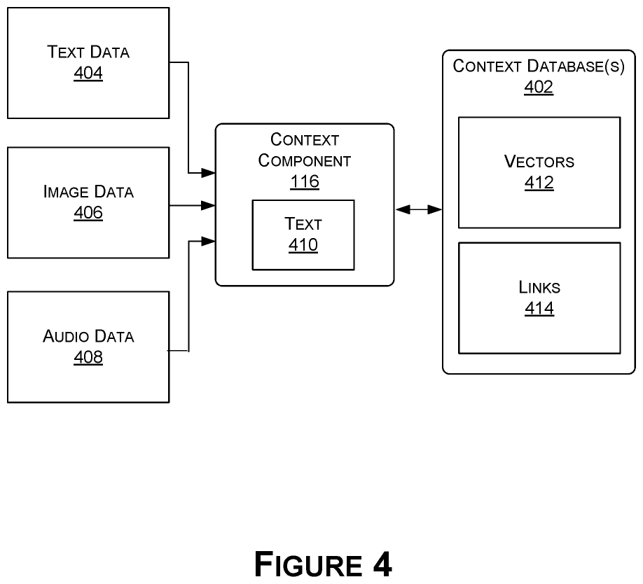

For instance, FIG. 4 illustrates an example of generating or updating one or more databases 402 (which may represent, and/or include, the database(s) 120) that store contextual information associated with an application, in accordance with some embodiments of the present disclosure. As shown, the context component 116 may identify external resources associated with the application. For example, the external resources may include, but are not limited to, documents, comments, discussion boards, websites, manuals, and/or any other textual information represented by text data 404, images, videos, graphics, and/or any other visual content represented by image data 406, and/or speech, sounds, and/or any other noises represented by audio data 408.

The context component 116 may then process the external sources in order to generate text 410. For a first example, if the external sources are associated with the text data 404, then the context component 116 may generate the text 410 to include the text from the documents, the comments, the discussion boards, the websites, the manuals, and/or the like. For a second example, if the external sources are associated with the image data 406, then the context component 116 may generate the text 410 to include a transcript of speech, descriptions of graphics, and/or any other information from the images, the videos, the graphics, and/or the like. Still, for a third example, if the external sources are associated with the audio data 408, then the context component 116 may generate the text 410 to include a transcript of the speech, a description of the noise, and/or any other information associated with the sound.

In some examples, the context component 116 may then segment the text 410 into chunks, such as characters, words, sentences, paragraphs, and/or any other portion of text. Additionally, the context component 116 may generate vectors 412 representing the chunks. Furthermore, in some examples, the context component 116 may generate links 414 that operate as pointers between the vectors 412 and the chunks, the text 410, and/or the external sources (e.g., the documents).

Referring back to the example of FIG. 1, to identify the contextual information, the context component 116 may search through the database(s) 120 in order to identify information that is relevant to the state information, the query, and/or one or more previous queries and/or previously generated information represented by history data 122. In some examples, to perform the search, the context component 116 may use one or more of the processes described herein (e.g., one or more encoders, etc.) to generate embeddings and/or vectors that represent the state information, the query, and/or the one or more previous queries and/or previously generated information. The context component 116 may then use the generated embeddings and/or vectors to search through the database(s) 120. Based at least on the search, the context component 116 may identify embeddings and/or vectors stored in the database(s) 120 that are similar to the generated embeddings and/or vectors. The context component 116 may then use those identified embeddings and/or vectors to retrieve the contextual information represented by the contextual data 118.

The process 100 may then include an input component 124 using at least a portion of the state data 106, at least a portion of the query data 114, at least a portion of the contextual data 118, and/or at least a portion of the history data 122 to generate input data 126 representing a prompt corresponding to the query. As described herein, in some examples, the input data 126 may represent tokens corresponding to the text represented by the state data 106, the query data 114, the contextual data 118, and/or the history data 122. In some examples, the input data 126 may represent vectors and/or embeddings corresponding to the tokens. In any example, the input component 124 may include and/or use any type of machine learning model, neural network, and/or the like that is configured to generate the input data 126 based at least on processing the state data 106, the query data 114, the contextual data 118, and/or the history data 122. For example, the input component 124 may include and/or use a convolutional neural network, a feed-forward neural network, a space invariant artificial neural network, a recurrent neural network, a perceptron, a transformer, and/or any other type of artificial intelligence network.

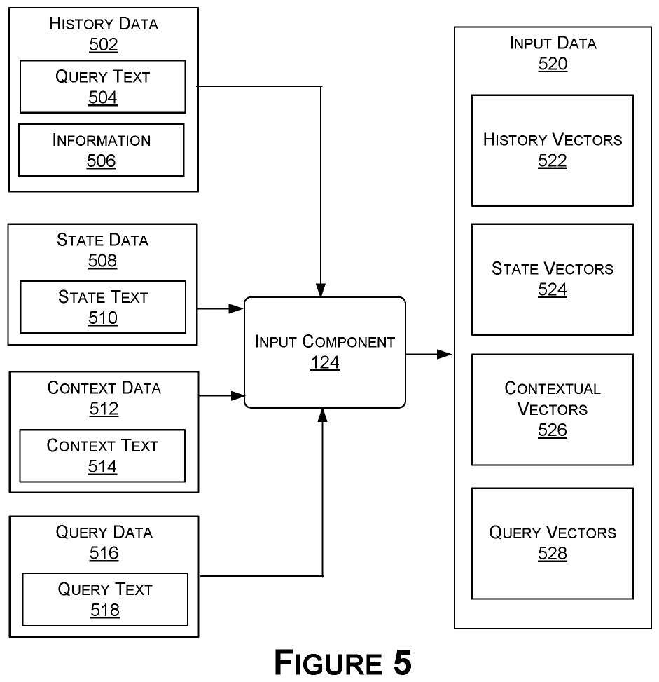

For instance, FIG. 5 illustrates an example of generating input data for one or more language models, in accordance with some embodiments of the present disclosure. As shown, the input component 124 may receive history data 502 (which may represent, and/or include, the history data 122) representing text 504 corresponding one or more of past queries and text 506 corresponding to output information associated with the one or more past queries, state data 508 (which may represent, and/or include, the state data 106) representing text 510 corresponding to state information associated with the application, contextual data 512 (which may represent, and/or include, the contextual data 118) representing text 514 corresponding to contextual information, and query data 516 (which may represent, and/or include, the query data 114) representing text 518 corresponding to the query. The input component 124 may then process the history data 502, the state data 508, the contextual data 512, and/or the query data 516 and, based at least on the processing, generate input data 520 (which may represent, and/or include, the input data 126) representing a prompt corresponding to the query.

As shown, the input data 520 may represent at least history vectors 522 corresponding to the history data 502, state vectors 524 corresponding to the state data 508, contextual vectors 526 corresponding to the contextual data 512, and query vectors 528 corresponding to the query data 516. In some examples, the prompt associated with the input data 520 may include a specific order, such as the history vectors 522, followed by the state vectors 524, followed by the contextual vectors 526, and finally followed by the query vectors 528. However, this is just one example of an order for the data associated with the prompt and, in other examples, the data associated with the prompt may include any other order.

Referring back to the example of FIG. 1, the process 100 may include applying the input data 126 to one or more language models 128. As described herein, the language model(s) 128 may include any type of language model, such as a statistical language model(s), a neural language model(s), a probabilistic language model(s), a fine-turned language model(s), a large language model(s), and/or the like. The language model(s) 128 may then be configured to process the input data 126 and, based at least on the processing, generate output data 130 representing information associated with the query. For example, the output data 130 may represent a response associated with the query. In some examples, the output data 130 may represent the information using embeddings and/or tokens. In such examples, an output component 132 may process the output data 130 in order to generate text corresponding to the information. However, in other examples, the output data 130 may already represent the text corresponding to the information.

In some examples, the information associated with the query may be generated based at least on one or more additional factors, such as the user information and/or user preferences. For instance, a user may provide an indication along with the query and/or as part of user preferences of a level of help to provide with regard to queries, where different levels are associated with varying amounts of help that are represented by the information. The language model(s) 126 may then use data representing the level, which may also be represented by the input data 126, when determining the information. For example, and using the examples above where the query is asking for the location of the main boss, the language model(s) 128 may determine first information for a first level of help, such as the exact location of the main boss, and second information for a second level of help, such as a general direction for which the main boss is located. This way, the user(s) is able to select the amount to help that the user(s) wants to receive for queries.

The process 100 may include the output component 132 processing the output data 130 and, based at least on the processing, generating content data 134 representing the information. In some examples, the content data 134 may include text data representing text associated with the information, where the client device(s) is then able to use the content data 134 to present the text. In some examples, the content data 134 may include audio data representing speech (e.g., one or more words) describing the information, where the client device(s) is then able to output the speech. In some examples, the content data 134 may include image data representing one or more graphics illustrating the information, where the client device(s) is then able to display the graphic(s). While these are just a few examples of the types of outputs that may be provided for the query, in other examples, additional and/or alternative types of outputs may be provided.

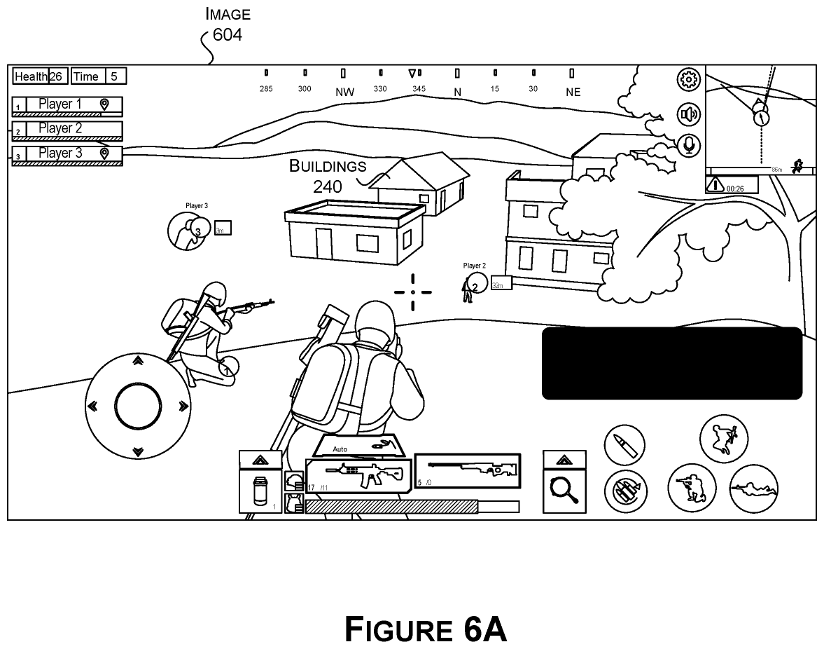

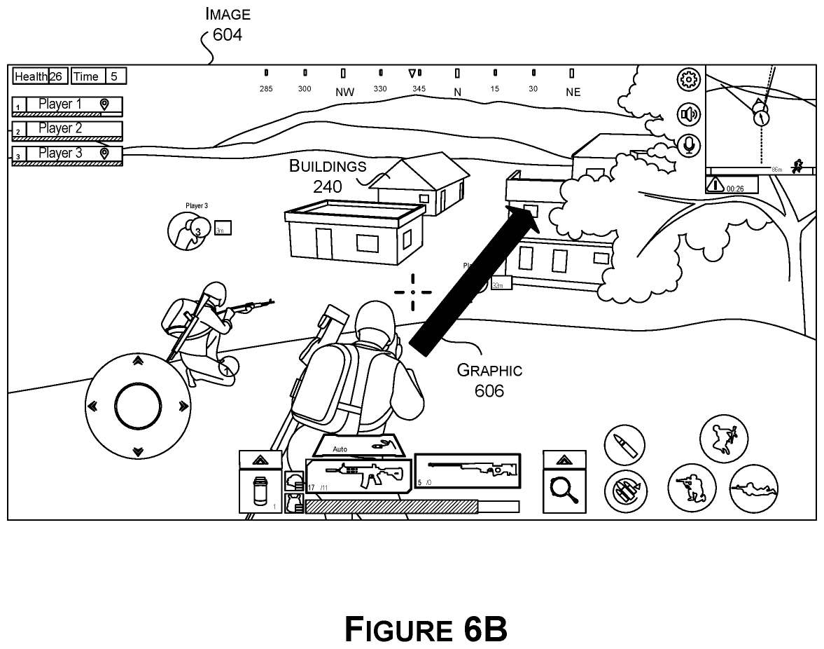

For instance, FIGS. 6A-6B illustrate examples of providing information associated with a query in an application, in accordance with some embodiments of the present disclosure. As shown by the example of FIG. 6A, content representing information associated with a query may include a graphical overlay 602 that includes text describing the information, where the graphical overlay 602 is over a frame 604 associated with the application. For example, and using one or more of the examples described herein, if the query includes, “Where can I find the main boss for this level,” then the information may include a response, “The main boss is in the right building on the second floor.” While the example of FIG. 6A illustrates the graphical overlay 602 presented at a specific location on the image 604, in other examples, the graphical overlay 602 may be presented at any other location on the image 604.

As shown by the example of FIG. 6B, the content representing information associated with the query may now include a graphical overlay 606 on the image 604 that includes an indicator. For example, and using one or more of the examples describes herein, if the query again includes, “Where can I find the main boss for this level,” then the graphical overlay 606 may include an arrow pointing in the direction to find the main boss. While the example of FIG. 6B illustrates the graphical overlay 606 as including an arrow, in other examples, the graphical overlay 606 may include any other type of graphic that is able to provide information associated with the query.

Referring back to the example of FIG. 1, while the example of FIG. 1 illustrates the input data 126 being generated using the state data 106, the query data 114, the contextual data 118, and the history data 122, in other examples, the input data 126 may be generated using only one or more of the state data 106, the query data 114, the contextual data 118, and the history data 122. Additionally, while the example of FIG. 1 illustrates the state component 102, the context component 116, the input component 124, and the output component 132 as being separate from the language model(s) 128, in other examples, one or more of the state component 102, the context component 116, the input component 124, and the output component 132 may be part of the language model(s) 128. For example, one or more of the state component 102, the context component 116, the input component 124, and the output component 132 may include one or more layers of the language model(s) 128.

Additionally, in some examples, the language model(s) 128 may be trained and/or configured to determine information associated with queries without using one or more of the state component 102, the context component 116, the input component 124, and the output component 132 associated with the process 100 of FIG. 1. For instance, the language model(s) 128 may be trained to receive the query data 114 representing the query along with the application data 104, such as a current frame associated with the application, and use the query data 114 and the application data 104 to determine the information (e.g., the response) associated with the query. In such an example, the language model(s) 128 and/or a separate component may be further configured to process the application data 104 in order to generate the state information, such as in the form of text that is needed for inputting into the language model(s) 128, but with using the received application data 104. In other words, the process 100 would not require continuously generating and/or updating the state of the application using the state component 102 and/or retrieving the contextual data 118 using the context component 116 in order for the language model(s) 128 to still be able to determine information associated with queries.

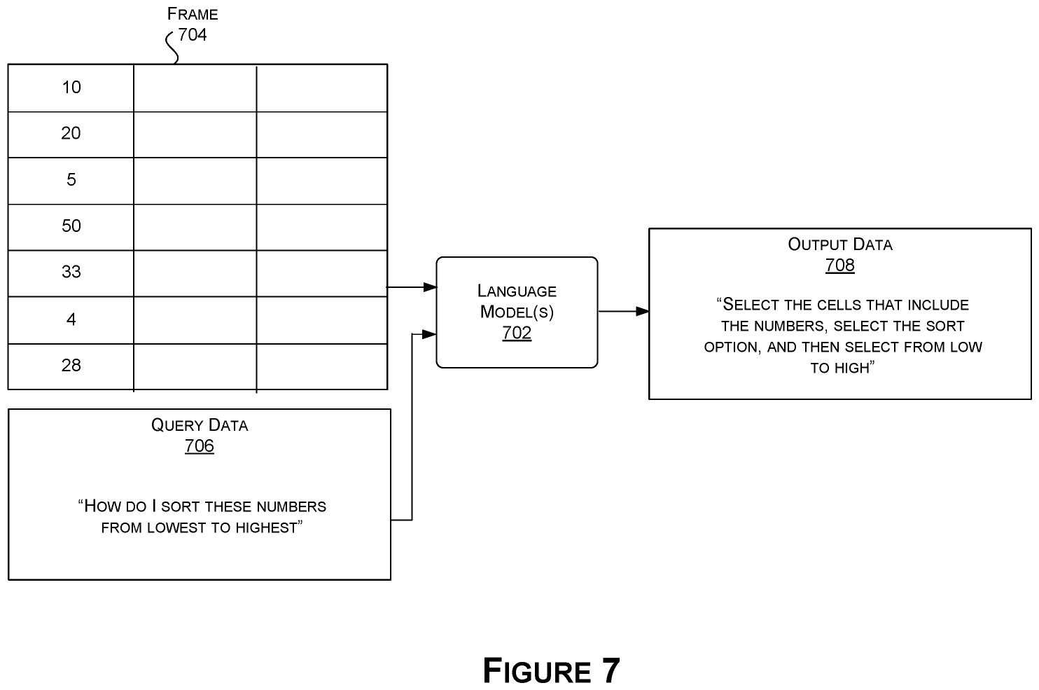

For instance, FIG. 7 illustrates an example of one or more language models 702 (which may represent, and/or include, the language model(s) 128) determining information associated with a query, in accordance with some embodiments of the present disclosure. As shown, the input to the language model(s) 702 may include application data representing at least a frame 704 of an application, where the frame 704 may be presented using the client device(s). However, in other examples, the application data may initially be processed using one or more other components, such as the state component 102, for generating text associated with the frame 704, which is described herein. Additionally, as shown, the input to the language model(s) 702 may include query data 706 (which may represent, and/or include, the query data 114) representing a query associated with the application. In the example of FIG. 7, the query may include, “How do I sort these numbers from lowest to highest.” While not illustrated in the example of FIG. 7, the language model(s) 702 and/or another component may process the application data and/or the query data 706 to generate vectors for inputting into the language model(s) 702.

The language model(s) 702 may be trained to process the input data and, based at least on the processing, generate output data 708 representing information associated with the query. For instance, the information includes a response that states, “Select the cells that include the numbers, select the sort option, and then select from low to high.” In some examples, the output data 708 may represent the text associated with the information. However, in other examples, the output data 708 may represent vectors corresponding to the text, where one or more other components (e.g., the output component 132) then process the output data 708 in order to generate the text. In any of the examples, by performing the process illustrated in the example of FIG. 7, the language model(s) 702 is able to generate information associated with the query using just the application data representing the frame 704 and the query data 706 representing the query.

Referring back to the example of FIG. 1, in some examples, one or more of the components may operate at frequencies that differ from one or more of the other components. For example, the state component 102 may operate using a first frequency (e.g., 0.5 Hz) in order to continue determining the states associated with the application while the language model(s) 128 operates at a second, lower frequency (e.g., 0.1) in order to determine information associated with queries. In such an example, the state component 102 may operate at the higher frequency in order to maintain the current state of the application while the language model(s) 128 operates at the lower frequency since processing is performed when a query is received, which may be infrequent.

While the examples described herein are directed to using the application data 104 to determine a state associated with an application and/or using the language model(s) 128 to determine information for queries, in some examples, the process 100 may be used for other tasks. For example, the application data 104 may represent a real-world environment, such as image data and/or audio data captured by one or more devices (e.g., one or more cameras) located within an environment. The state component 102 may then use the application data 104 to determine a state associated with the environment and/or one or more users located within the environment. Additionally, based at least on receiving queries, which may be included as part of the captured data, the language model(s) 128 may use the state data 106 representing the state of the environment along with the query data 114 representing the query to determine information associated with the environment and/or the user(s), where the information is provided back to the user(s). In such an example, the language model(s) 128 may also use contextual information retrieved from the database(s) 120, such as contextual information that includes information associated with the user(s).

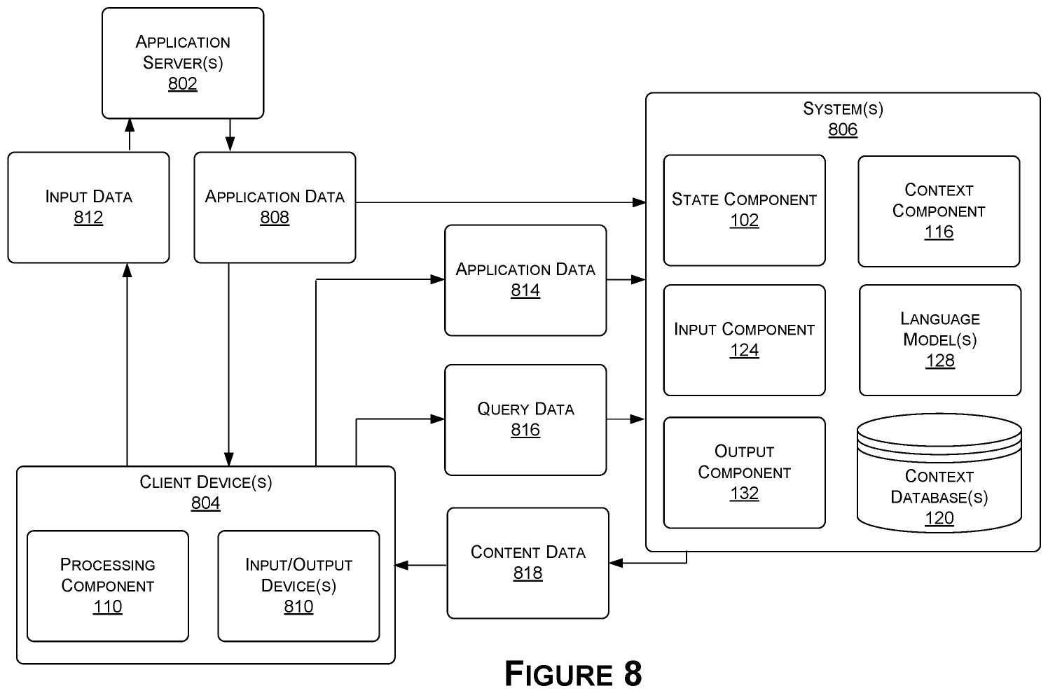

As described herein, in some examples, one or more of the components may be operating using one or more first computing devices (e.g., a frontend) while one or more other components may be operating using one or more second computing devices (e.g., a backend). For instance, FIG. 8 illustrates an example of an architecture for providing an AI assistant associated with an application, in accordance with some embodiments of the present disclosure. As shown, the architecture may include at least one or more application servers 802, one or more client devices 804, and one or more systems 806. While the example of FIG. 8 illustrates the system(s) 806 as being separate from the application server(s) 802 and the client device(s) 804, in other examples, the system(s) 806 may be included as part of the application server(s) 802 and/or the client device(s) 804.

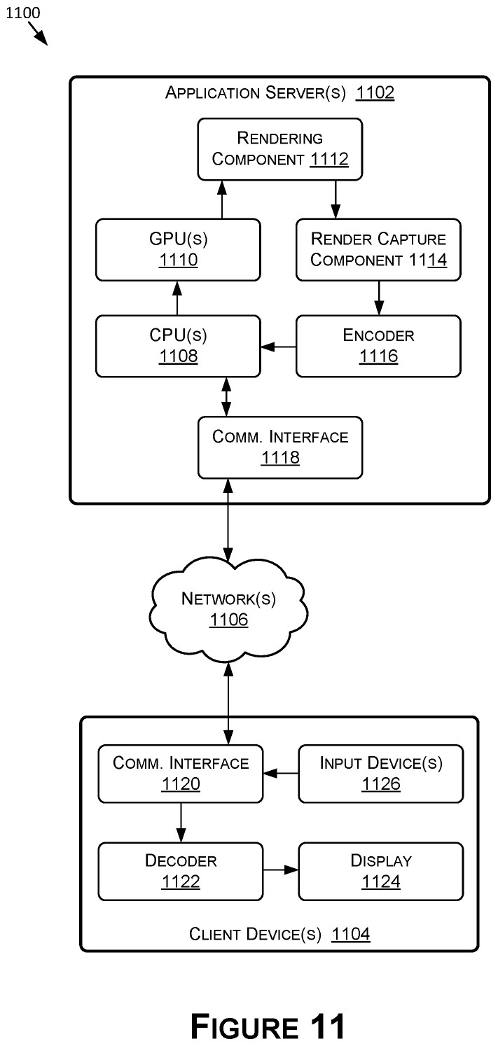

As described in more detail with respect to FIG. 11, the application server(s) 802 may be configured to send application data 808 (which may represent, and/or include, the application data 104) to the client device(s) 804, where the client device(s) 804 then uses the application data 808 to provide content associated with the application. For example, the client device(s) 804 may present one or more frames represented by the application data 808 using one or more displays and/or output sound represented by the application data 808 using one or more speakers, where the display(s) and/or the speaker(s) may include one or more output devices 810. Additionally, the client device(s) 804 may send input data 812 to the application server(s) 802, where the input data 812 represents one or more inputs received using one or more input devices 810 (e.g., a controller, a microphone, a keyboard, a mouse, etc.). The application server(s) 802 may then use the input data 812 to update one or more states associated with the application.

As further shown, the application server(s) 802 may send the application data 808 to the system(s) 806 and/or the client device(s) 804 may send application data 814 (which may also represent, and/or include, the application data 104) to the system(s) 806. As described herein, the application data 814 may represent at least a portion of the application data 808 and/or at least a portion of the input data 812. Additionally, the client device(s) 804 may use the processing component 110 to generate query data 816 (which may represent, and/or include, the query data 114) representing a query, using one or more of the processes described herein. The client device(s) 804 may then send the query data 816 to the system(s) 806.

In the example of FIG. 8, the system(s) 806 may then use the state component 102, the context component 116, the input component 124, the language model(s) 128, and/or the output component 132 to process the application data 808, the application data 814, and/or the query data 816 using one or more of the processes described herein with respect to FIG. 1. For instance, based at least on processing the application data 808, the application data 814, and/or the query data 816, the system(s) 806 may generate content data 818 (which may represent, and/or include, the content data 134) representing the information associated with the query. As described herein, the content data 818 may represent text describing the information, audio corresponding to one or more words describing the information, one or more graphics indicating the information, and/or any other type of output. The system(s) 806 may then send the content data 818 to the client device(s) 804.

While the example of FIG. 8 illustrates the client device(s) 804 as including the processing component 110 and the system(s) 806 as including the state component 102, the context component 116, the input component 124, the language model(s) 128, and/or the output data 130, in other examples, the state component 102, the processing component 110, the context component 116, the input component 124, the language model(s) 128, and/or the output component 132 may be separated differently between the application server(s) 802, the client device(s) 804, and/or the system(s) 806. Additionally, in some examples, the system(s) 806 may not include one or more of the state component 102, the context component 116, the input component 124, the language model(s) 128, and/or the output component 132.

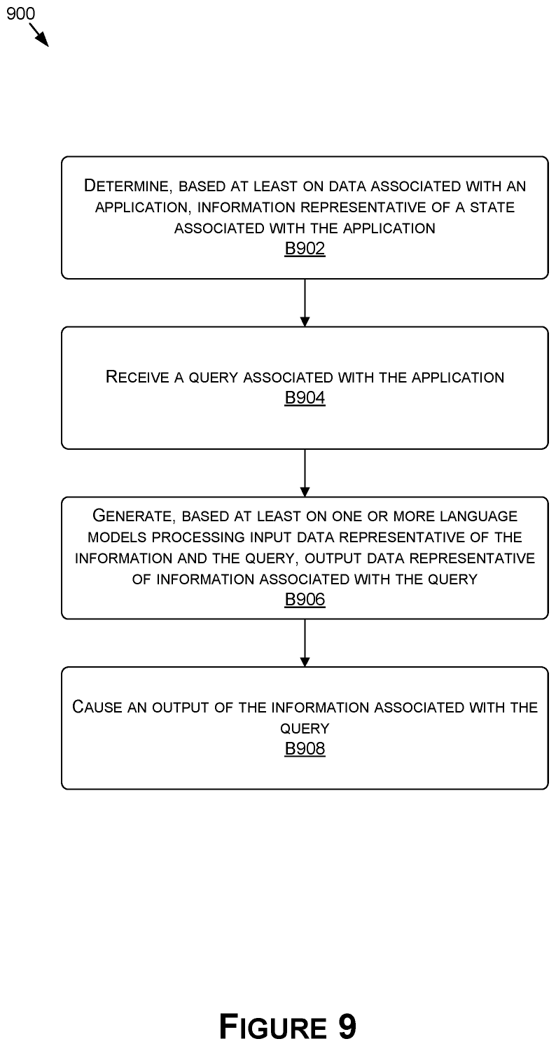

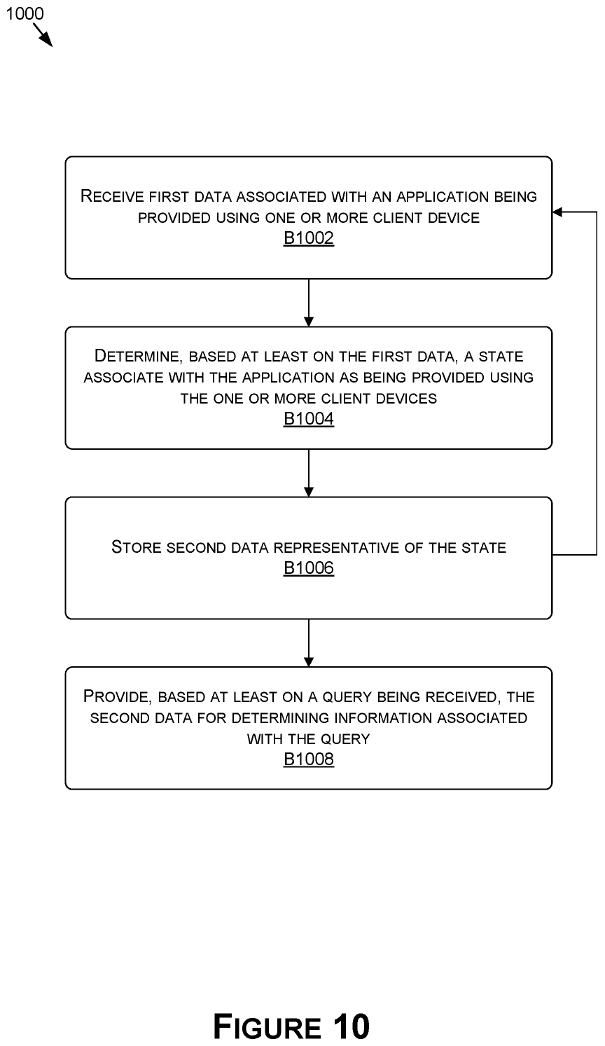

Now referring to FIGS. 9 and 10, each block of methods 900 and 1000, described herein, comprises a computing process that may be performed using any combination of hardware, firmware, and/or software. For instance, various functions may be carried out by a processor executing instructions stored in memory. The methods 900 and 1000 may also be embodied as computer-usable instructions stored on computer storage media. The methods 900 and 1000 may be provided by a standalone application, a service or hosted service (standalone or in combination with another hosted service), or a plug-in to another product, to name a few. In addition, the methods 900 and 1000 are described, by way of example, with respect to FIG. 1. However, these methods 900 and 1000 may additionally or alternatively be executed by any one system, or any combination of systems, including, but not limited to, those described herein.

FIG. 9 illustrates a flow diagram showing a method 900 for using one or more language models to provide information related to queries associated with an application, in accordance with some embodiments of the present disclosure. The method 900, at block B902, may include determining, based at least on data associated with an application, information representative of a state associated with the application. For instance, a system(s) (e.g., the system(s) 806, which may use the state component 102) may receive the application data 104 from the application server(s) and/or the client device(s). As described herein, the application data 104 may represent frames being presented using the client device(s), frames associated with one or more other FOVs associated with the application, audio being output using the client device(s), input(s) being received using the client device(s), audio being received using the client device(s), user data representing information associated with a user(s) of the client device(s), and/or any other data. The system(s) may then process the application data 104 in order to determine information associated with the state, where the information may be represented by the state data 106. As described herein, in some examples, the information may represent the state using text that describes one or more characteristics associated with the state.

The method 900, at block B904, may include receiving a query associated with the application. For instance, the system(s) may receive the query data 114 from the client device(s), where the query data 114 represents the query. As described herein, the query may include a request for information associated with the application, a question on how to perform a task associated with the application, an inquiry associated with the application, and/or any other type of query. Additionally, in some examples, the query data 114 may represent the query using text.

The method 900, at block B906, may include generating, based at least on one or more language models processing input data representative of the information and the query, output data representative of information associated with the query. For instance, the system(s) (e.g., the input component 124, etc.) may initially generate the input data 126 representing a prompt that includes at least the information and the query. In some examples, the prompt may include additional information, such as the contextual information represented by the contextual data 118 and/or the past queries and/or information represented by the history data 122. The system(s) may then apply the input data 126 to the language model(s) 128 that is configured to process the input data 126 and, based at least on the processing, generate the output data 130 representing the information associated with the query. In some examples, the system(s) (e.g., the language model(s) 128, the output component 132, etc.) may then generate the content data 134 using the output data 130.

The method 900, at block B908, may include causing an output of the information associated with the query. For instance, the system(s) may cause the output of the information, such as by transmitting the content data 134 to the client device(s). As described herein, the client device(s) may output the information by displaying text corresponding to the information, display a graphic corresponding to the information, outputting audio corresponding to the information, and/or using any other technique.

FIG. 10 illustrates a flow diagram showing a method 1000 for maintaining a state associated with an application, in accordance with some embodiments of the present disclosure. The method 1000, at block B1002, may include receiving first data associated with an application being provided using one or more client devices. For instance, a system(s) (e.g., the system(s) 806, such as by using the state component 102) may receive the application data 104 from the application server(s) and/or the client device(s). As described herein, the application data 104 may represent frames being presented using the client device(s), frames associated with one or more other FOVs associated with the application, audio being output using the client device(s), an input(s) being received using the client device(s), audio received using the client device(s), user data representing information associated with a user(s) of the client device(s), and/or any other data.

The method 1000, at block B1004, may include determining, based at least on the first data, a state associated with the application as being provided using the one or more client devices. For instance, the system(s) may determine, based at least on the application data 104, the state associated with the application. As described herein, the system(s) may determine the state from the application data 104 by performing one or more types of processing, such as OCR, CV, audio processing, input processing, and/or any other type of processing. Additionally, in some examples, the system(s) may determine the state as being represented using information, such as text, describing one or more characteristics associated with the application.

The method 1000, at block B1006, may include storing second data representative of the state. For instance, the system(s) may store the state data 106 associated with the state, such as part of the state history data 108. As shown, blocks B1002, B10004, and B1006 may then continue to repeat so that the system(s) continues to receive new data associated with the application and then update the state associated with the application using the new data. This way, the state data 106 represents the current state of the application as being provided using the client device(s).

The method 1000, at block B1008, may include providing, based at least on a query being received, the second data for determining information associated with the query. For instance, the system(s) may use the state data 106 to determine the information associated with the query. As such, and by performing the updates described herein, the system(s) may use the most current state, as represented by the state data 106, that is the most relevant to the query.

### Example Content Streaming System

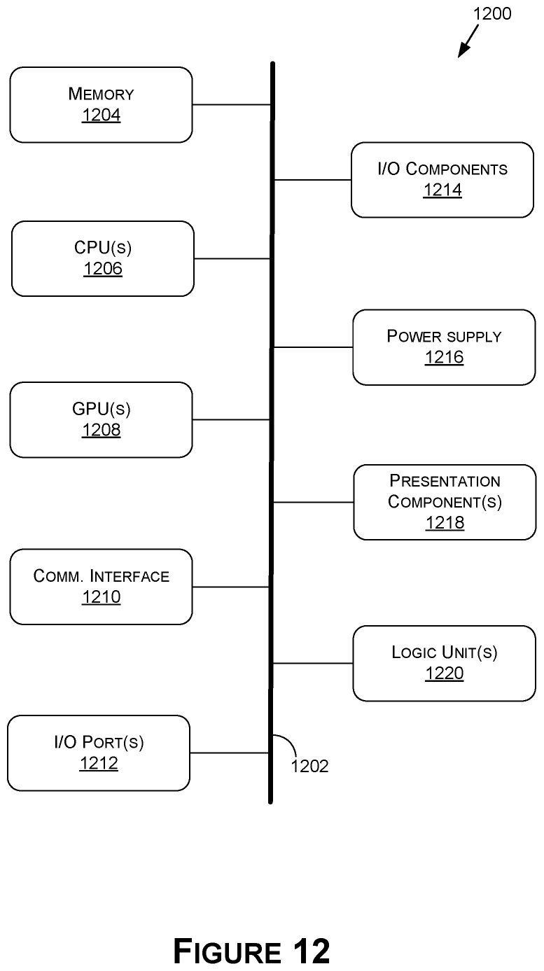

Now referring to FIG. 11, FIG. 11 is an example system diagram for a content streaming system 1100, in accordance with some embodiments of the present disclosure. FIG. 11 includes application server(s) 1102 (which may include similar components, features, and/or functionality to the example computing device 1200 of FIG. 12 and/or the application server(s) 802), client device(s) 1104 (which may include similar components, features, and/or functionality to the example computing device 1200 of FIG. 12 and/or the client device(s) 804), and network(s) 1106 (which may be similar to the network(s) described herein). In some embodiments of the present disclosure, the system 1100 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 1100, for an application session, the client device(s) 1104 may only receive input data in response to inputs to the input device(s), transmit the input data to the application server(s) 1102, receive encoded display data from the application server(s) 1102, and display the display data on the display 1124. As such, the more computationally intense computing and processing is offloaded to the application server(s) 1102 (e.g., rendering—in particular ray or path tracing—for graphical output of the application session is executed by the GPU(s) of the game server(s) 1102). In other words, the application session is streamed to the client device(s) 1104 from the application server(s) 1102, thereby reducing the requirements of the client device(s) 1104 for graphics processing and rendering.

For example, with respect to an instantiation of an application session, a client device 1104 may be displaying a frame of the application session on the display 1124 based on receiving the display data from the application server(s) 1102. The client device 1104 may receive an input to one of the input device(s) and generate input data in response. The client device 1104 may transmit the input data to the application server(s) 1102 via the communication interface 1120 and over the network(s) 1106 (e.g., the Internet), and the application server(s) 1102 may receive the input data via the communication interface 1118. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1112 may render the application session (e.g., representative of the result of the input data) and the render capture component 1114 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 1102. In some embodiments, one or more virtual machines (VMs)—e.g., including one or more virtual components, such as vGPUs, vCPUs, etc.—may be used by the application server(s) 1102 to support the application sessions. The encoder 1116 may then encode the display data to generate encoded display data and the encoded display data may be transmitted to the client device 1104 over the network(s) 1106 via the communication interface 1118. The client device 1104 may receive the encoded display data via the communication interface 1120 and the decoder 1122 may decode the encoded display data to generate the display data. The client device 1104 may then display the display data via the display 1124.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

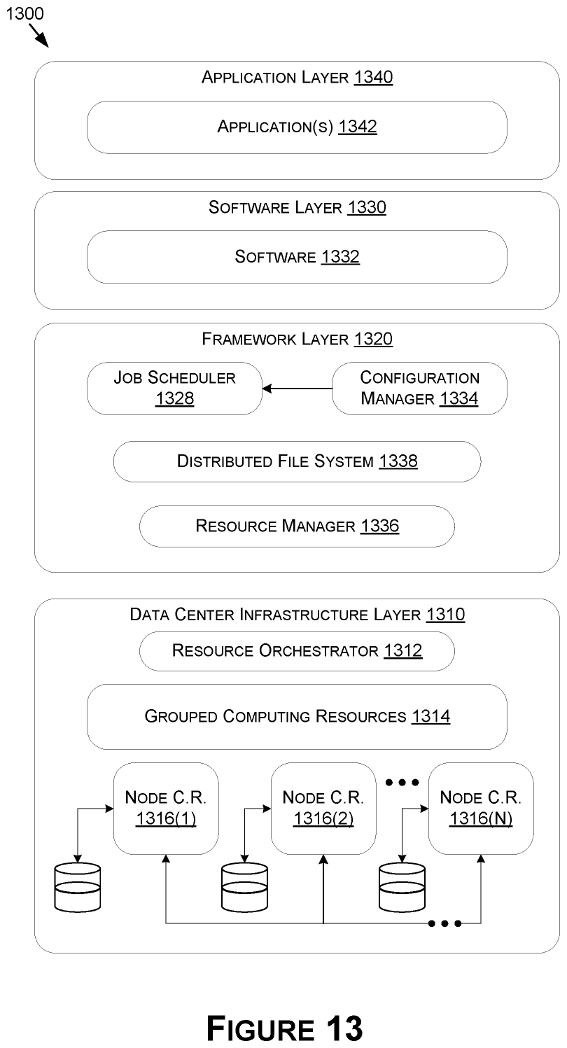

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Clauses

A: A method comprising: determining, based at least on content data associated with a gaming application, information representative of a state of the gaming application; receiving a query associated with the gaming application; generating, using one or more language models and based on the one or more language models processing input data representative of the information and the query, output data representative of a response associated with the query; and causing a client device to output the response associated with the query.

B: The method of paragraph A, further comprising: retrieving, from one or more databases and based at least on at least one of the information or the query, second information describing a context associated with the gaming application, wherein the input data is further representative of the second information.

C: The method of paragraph B, wherein the second information comprises text describing at least a portion of one or more of: one or more documents associated with the gaming application; one or more videos associated with the gaming application; one or more instances of user speech associated with the gaming application; or one or more graphics associated with the gaming application.

D: The method of any one of paragraphs A-C, further comprising: storing data representative of at least one of one or more previous queries associated with the gaming application or one or more previous responses associated with the gaming application, wherein the input data is further representative of the at least one of the one or more previous queries or the one or more previous responses.

E: The method of any one of paragraphs A-D, wherein the content data comprises at least image data representative of one or more frames, and wherein the determining the information representing the state of the gaming application comprises: determining, based at least on the image data, at least one of: first text represented by the one or more frames; or second text describing one or more elements graphically represented by the one or more frames; and generating the information to include at least one of the first text or the second text.

F: The method of any one of paragraph A-E, wherein the content data comprises one or more of: image data representative of one or more frames presented using the client device; first audio data representative of a first sound that is output using the client device; second audio data representative of a second sound captured using the client device; or input data representative of one or more inputs received using the client device.

G: The method of any one of paragraphs A-F, further comprising: determining, based at least on second content data representative of the gaming application, second information representing a second state of the gaming application, wherein the determining the information representing the state of the gaming application is further based at least on the second information.

H: The method of any one of paragraphs A-G, further comprising: generating the input data to represent at least one or more first vectors representative of first text corresponding to the information and one or more second vectors representative of second text corresponding to the query; and generating, based at least on one or more third vectors represented by the output data, third text corresponding to the response, wherein the causing the output is based at least on the third text.

I: The method of any one of paragraphs A-H, wherein the causing the client device to output the response associated with the query comprises transmitting, to the client device, data that causes one or more of: the client device to output sound associated with the response; the client device to display text associated with the response; or the client device to display one or more graphical elements associated with the response.

J: A system comprising: one or more processors to: determine, based at least on first data representative of an application, first information representative of a state associated with the application; receive a query associated with the application; generate, based at least on one or more language models processing input data representative of the first information and the query, output data representative of second information associated with the query; and cause an output of the second information associated with the query.

K: The system of paragraph J, wherein the one or more processors are further to: retrieve, from one or more databases and based at least on at least one of the first information or the query, third information representative of a context associated with the application, wherein the input data is further representative of the third information.

L: The system of paragraph K, wherein the third information comprises text describing at least a portion of one or more of: one or more documents associated with the application; one or more videos associated with the application; one or more instances of user speech associated with the application; or one or more graphics associated with the application.

M: The system of any one of paragraphs J-L, wherein the one or more processors are further to: store second data representative of at least one of one or more previous queries associated with the application or fourth information associated with the one or more previous queries, wherein the input data is further representative of the at least one of the one or more previous queries and the fourth information.

N: The system of any one of paragraphs J-M, wherein the first data comprises at least image data representative of one or more frames, and wherein the determination of the first information representative of the state associated with the application comprises: determining, based at least on the image data, at least one of: first text represented by the one or more frames; or second text describing one or more elements graphically represented by the one or more frames; and generating the first information to include at least one of the first text or the second text.

O: The system of any one of paragraphs J-N, wherein the one or more processors are further to: determine, based at least on subsequent data representative of the application, subsequent information representative of a second state associated with the application, wherein the determination of the first information is further based at least on the subsequent information.

P: The system of any one of paragraphs J-O, wherein the one or more processors are further to: generate the input data to include one or more first vectors representative of first text corresponding to the first information and one or more second vectors representative of second text corresponding to the query; and generate, based at least on one or more third vectors included in the output data, third text corresponding to the second information.

Q: The system of any one of paragraphs J-P, wherein the one or more processors are further to: receive the first data using at least one of a client device presenting content associated with the application or a system streaming the application, wherein: the query is received using the client device; and the second information is sent to the client device in order to cause the client device to output the second information.

R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to cause a client device to output a response to a query associated with an interactive application, wherein the response is determined based at least on one or more language models processing data representative of state information associated with the interactive application and the query, the state information being determined based at least on content data associated with the interactive application.

T: The one or more processors of paragraph S, wherein the one or more processors is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
determining, based at least on content data associated with a gaming application, information representative of a state of the gaming application;
receiving a query associated with the gaming application;
generating, using one or more language models and based on the one or more language models processing input data representative of the information and the query, output data representative of a response associated with the query; and
causing a client device to output the response associated with the query.

2. The method of claim 1, further comprising:
retrieving, from one or more databases and based at least on at least one of the information or the query, second information describing a context associated with the gaming application,
wherein the input data is further representative of the second information.

3. The method of claim 2, wherein the second information comprises text describing at least a portion of one or more of:
one or more documents associated with the gaming application;
one or more videos associated with the gaming application;
one or more instances of user speech associated with the gaming application; or
one or more graphics associated with the gaming application.

4. The method of claim 1, further comprising:
storing data representative of at least one of one or more previous queries associated with the gaming application or one or more previous responses associated with the gaming application,
wherein the input data is further representative of the at least one of the one or more previous queries or the one or more previous responses.

5. The method of claim 1, wherein the content data comprises at least image data representative of one or more frames, and wherein the determining the information representing the state of the gaming application comprises:
determining, based at least on the image data, at least one of:
first text represented by the one or more frames; or
second text describing one or more elements graphically represented by the one or more frames; and
generating the information to include at least one of the first text or the second text.

6. The method of claim 1, wherein the content data comprises one or more of:
image data representative of one or more frames presented using the client device;
first audio data representative of a first sound that is output using the client device;
second audio data representative of a second sound captured using the client device; or
input data representative of one or more inputs received using the client device.

7. The method of claim 1, further comprising:
determining, based at least on second content data representative of the gaming application, second information representing a second state of the gaming application,
wherein the determining the information representing the state of the gaming application is further based at least on the second information.

8. The method of claim 1, further comprising:
generating the input data to represent at least one or more first vectors representative of first text corresponding to the information and one or more second vectors representative of second text corresponding to the query; and
generating, based at least on one or more third vectors represented by the output data, third text corresponding to the response,
wherein the causing the output is based at least on the third text.

9. The method of claim 1, wherein the causing the client device to output the response associated with the query comprises transmitting, to the client device, data that causes one or more of:
the client device to output sound associated with the response;
the client device to display text associated with the response; or
the client device to display one or more graphical elements associated with the response.

10. A system comprising:
one or more processors to:
determine, based at least on first data representative of an application, first information representative of a state associated with the application;
receive a query associated with the application;
generate, based at least on one or more language models processing input data representative of the first information and the query, output data representative of second information associated with the query; and
cause an output of the second information associated with the query.

11. The system of claim 10, wherein the one or more processors are further to:
retrieve, from one or more databases and based at least on at least one of the first information or the query, third information representative of a context associated with the application,
wherein the input data is further representative of the third information.

12. The system of claim 11, wherein the third information comprises text describing at least a portion of one or more of:
one or more documents associated with the application;
one or more videos associated with the application;
one or more instances of user speech associated with the application; or
one or more graphics associated with the application.

13. The system of claim 10, wherein the one or more processors are further to:
store second data representative of at least one of one or more previous queries associated with the application or fourth information associated with the one or more previous queries,
wherein the input data is further representative of the at least one of the one or more previous queries and the fourth information.

14. The system of claim 10, wherein the first data comprises at least image data representative of one or more frames, and wherein the determination of the first information representative of the state associated with the application comprises:
determining, based at least on the image data, at least one of:
first text represented by the one or more frames; or
second text describing one or more elements graphically represented by the one or more frames; and
generating the first information to include at least one of the first text or the second text.

15. The system of claim 10, wherein the one or more processors are further to:
determine, based at least on subsequent data representative of the application, subsequent information representative of a second state associated with the application,
wherein the determination of the first information is further based at least on the subsequent information.

16. The system of claim 10, wherein the one or more processors are further to:
generate the input data to include one or more first vectors representative of first text corresponding to the first information and one or more second vectors representative of second text corresponding to the query; and
generate, based at least on one or more third vectors included in the output data, third text corresponding to the second information.

17. The system of claim 10, wherein the one or more processors are further to:
receive the first data using at least one of a client device presenting content associated with the application or a system streaming the application,
wherein:
the query is received using the client device; and
the second information is sent to the client device in order to cause the client device to output the second information.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to cause a client device to output a response to a query associated with an interactive application, wherein the response is determined based at least on one or more language models processing data representative of state information associated with the interactive application and the query, the state information being determined based at least on content data associated with the interactive application.

20. The one or more processors of claim 19, wherein the one or more processors is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
